(19) United States
(12) Patent Application Publication
(10) Pub. No.: US 2016/0008970 A1
(43) Pub. Date: Jan. 14, 2016

(54) Socket Tool

(71) Applicant: Yu-Hui Ho, Taichung City (TW)

(72) Inventor: Yu-Hui Ho, Taichung City (TW)

(21) Appl. No.: 14/330,024

(22) Filed: Jul. 14, 2014

(51) Int. Cl. B25G 1/06; F16B 21/16

(52) U.S. Cl. CPC B25G 1/066; F16B 21/165

(57) ABSTRACT

A socket tool includes a handle, a pivot member connected with the handle, a threaded rod connecting the pivot member and the handle, and a quick release member mounted in the pivot member. The handle has a first end provided with a grip portion and a second end provided with a mounting portion. The mounting portion of the handle has an outer periphery provided with a plurality of retaining grooves and a pressing block. The pivot member has a connector provided with a channel for mounting the quick release member. Thus, the quick release member is locked in any one of the retaining grooves of the handle so that the angle between the handle and the pivot member can be adjusted freely to adjust the angle between the handle and the driving socket in a multi-stage manner.

### BACKGROUND OF THE INVENTION

1. Field of the Invention

The present invention relates to a hand tool and, more particularly, to a socket tool for operating a driving socket to drive a workpiece, such as a nut and the like.

2. Description of the Related Art

A conventional socket tool comprises a handle, a driving socket and a pivot member. The driving socket is pivotally mounted on the handle by the pivot member. The pivot member functions as a fulcrum so that the driving socket is pivoted about the pivot member. Thus, the driving socket is pivoted relative to the handle to change the angle between the driving socket and the handle so that the user can change the operation angle of the driving socket according to the working requirement. However, the driving socket and the handle do not have any positioning function so that the driving socket is pivoted freely on the handle, thereby causing inconvenience to the user when operating the driving socket and the handle. In addition, the driving socket cannot be replaced so that the user has to prepare and carry socket tools with driving sockets of different sizes, thereby causing inconvenience to the user, and thereby increasing the cost.

### BRIEF SUMMARY OF THE INVENTION

In accordance with the present invention, there is provided a socket tool comprising a handle, a pivot member connected with the handle, a threaded rod connecting the pivot member and the handle, a quick release member mounted in the pivot member, and a compression spring mounted on the quick release member. The handle has a first end provided with a grip portion and a second end provided with a mounting portion. The mounting portion of the handle is provided with a transverse through hole. The mounting portion of the handle has an outer periphery provided with a plurality of retaining grooves and a pressing block. The pivot member is mounted on the mounting portion of the handle. The pivot member has a first end provided with a screw hole and a second end provided with a connector. The connector of the pivot member has an interior provided with a channel. The quick release member is mounted in the channel of the connector. The quick release member has a first end provided with a positioning protrusion.

Preferably, the channel of the connector has a stepped shape.

Preferably, the socket tool further comprises a positioning ball mounted on the pivot member. The quick release member has a second end provided with a shaft. The shaft of the quick release member is provided with a limit depression and a release recess connected to the limit depression. The positioning ball is received in the limit depression or the release recess of the quick release member.

Preferably, the compression spring is mounted on the shaft of the quick release member and received in the channel of the connector.

Preferably, the pressing block of the handle is integrally formed on the mounting portion.

Alternatively, the pressing block of the handle consists of a bore formed in the mounting portion and a ball embedded in the bore.

Preferably, the positioning protrusion of the quick release member is received in one of the retaining grooves of the handle or abuts the pressing block of the handle.

Preferably, the threaded rod extends through the screw hole of the pivot member and the through hole of the handle, with the pivot member being pivotally mounted on the mounting portion of the handle and is pivotable about the threaded rod.

Preferably, the positioning ball is movably mounted on the connector of the pivot member and partially extended into the channel of the connector.

Preferably, the compression spring is biased between the positioning protrusion of the quick release member and the connector of the pivot member to push the positioning protrusion of the quick release member toward the mounting portion of the handle.

According to the primary advantage of the present invention, the quick release member is mounted in the pivot member and is locked in any one of the retaining grooves of the handle so that the angle between the handle and the pivot member can be adjusted freely to adjust the angle between the handle and the driving socket in a multi-stage manner so as to satisfy the requirement of different working sites and to facilitate the user operating the driving socket.

According to another advantage of the present invention, when the quick release member is pressed by the pressing block of the handle, the positioning ball is detached from the locking groove of the driving socket to unlock the driving socket from the connector of the pivot member, so that the driving socket can be removed from the pivot member easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a socket tool in accordance with the preferred embodiment of the present invention.

FIG. 2 is an exploded perspective view of the socket tool as shown in FIG. 1.

FIG. 3 is another perspective view of a handle of the socket tool as shown in FIG. 2.

FIG. 4 is a perspective view of the socket tool for a driving socket in accordance with the preferred embodiment of the present invention.

FIG. 5 is a cross-sectional view of the socket tool for a driving socket as shown in FIG. 4.

FIG. 6 is a schematic operational view of the socket tool as shown in FIG. 5.

FIG. 7 is a schematic operational view of the socket tool as shown in FIG. 6.

FIG. 8 is a schematic operational view of the socket tool as shown in FIG. 5.

### DETAILED DESCRIPTION OF THE INVENTION

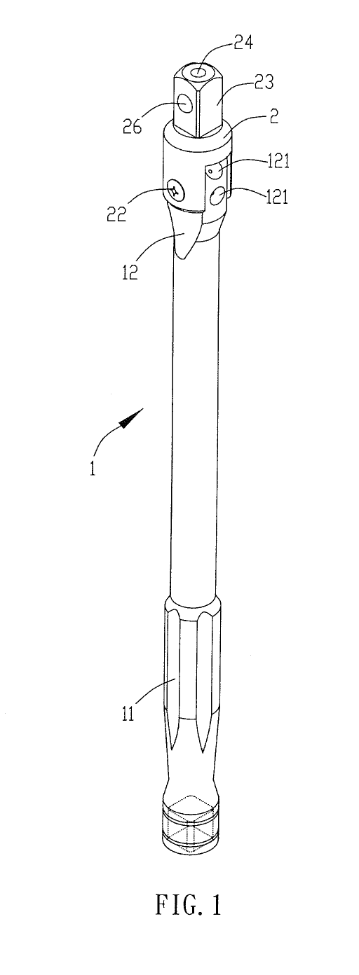

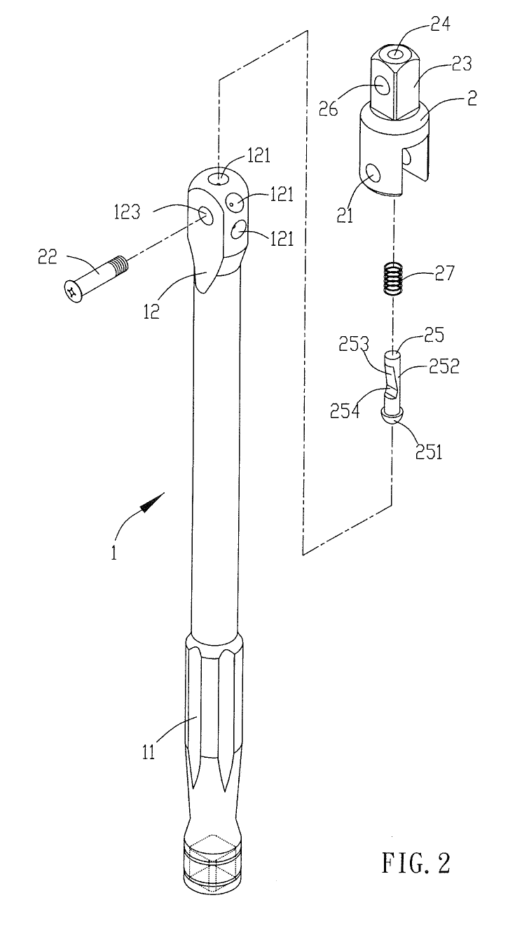

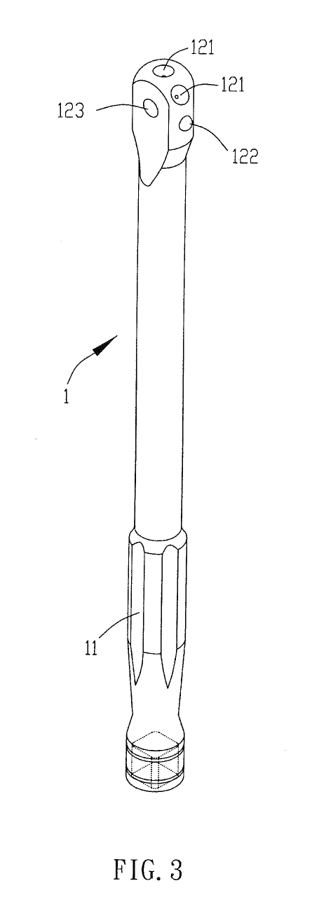

Referring to the drawings and initially to FIGS. 1-3, a socket tool in accordance with the preferred embodiment of the present invention comprises a handle 1, a pivot member 2 connected with the handle 1, a threaded rod 22 connecting the pivot member 2 and the handle 1, a quick release member 25 mounted in the pivot member 2, a compression spring 27 mounted on the quick release member 25, and a positioning ball 26 mounted on the pivot member 2.

The handle 1 is an elongate rod and has a first end provided with a grip portion 11 and a second end provided with a mounting portion 12. The mounting portion 12 of the handle 1 is provided with a transverse through hole 123. The mounting portion 12 of the handle 1 has an outer periphery provided with a plurality of retaining grooves 121 and a pressing block 122. The retaining grooves 121 of the handle 1 are distant equally from each other. Preferably, the pressing block 122 of the handle 1 is integrally formed on the mounting portion 12. Alternatively, the pressing block 122 of the handle 1 consists of a bore formed in the mounting portion 12 and a ball embedded in the bore.

The pivot member 2 is mounted on the mounting portion 12 of the handle 1. The pivot member 2 has a first end provided with a screw hole 21 and a second end provided with a connector 23. The connector 23 of the pivot member 2 has an interior provided with a channel 24. Preferably, the channel 24 of the connector 23 has a stepped shape.

The threaded rod 22 extends through the screw hole 21 of the pivot member 2 and the through hole 123 of the handle 1 so that the pivot member 2 is pivotally mounted on the mounting portion 12 of the handle 1 and is pivotable about the threaded rod 22.

The quick release member 25 is mounted in the channel 24 of the connector 23. The quick release member 25 has a first end provided with a positioning protrusion 251 and a second end provided with a shaft 252. The positioning protrusion 251 of the quick release member 25 is received in one of the retaining grooves 121 of the handle 1 or abuts the pressing block 122 of the handle 1. The shaft 252 of the quick release member 25 is provided with a limit depression 253 and a release recess 254 connected to the limit depression 253.

The positioning ball 26 is movably mounted on the connector 23 of the pivot member 2 and partially extended into the channel 24 of the connector 23. The positioning ball 26 is received in the limit depression 253 or the release recess 254 of the quick release member 25.

The compression spring 27 is mounted on the shaft 252 of the quick release member 25 and received in the channel 24 of the connector 23. The compression spring 27 is biased between the positioning protrusion 251 of the quick release member 25 and the connector 23 of the pivot member 2 to push the positioning protrusion 251 of the quick release member 25 toward the mounting portion 12 of the handle 1.

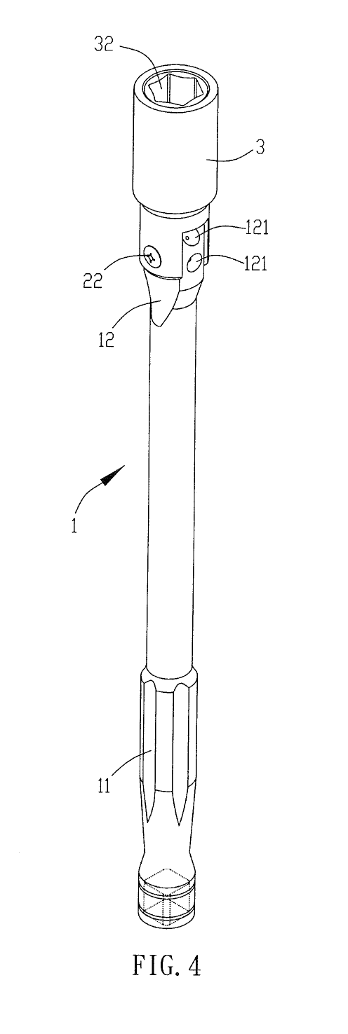

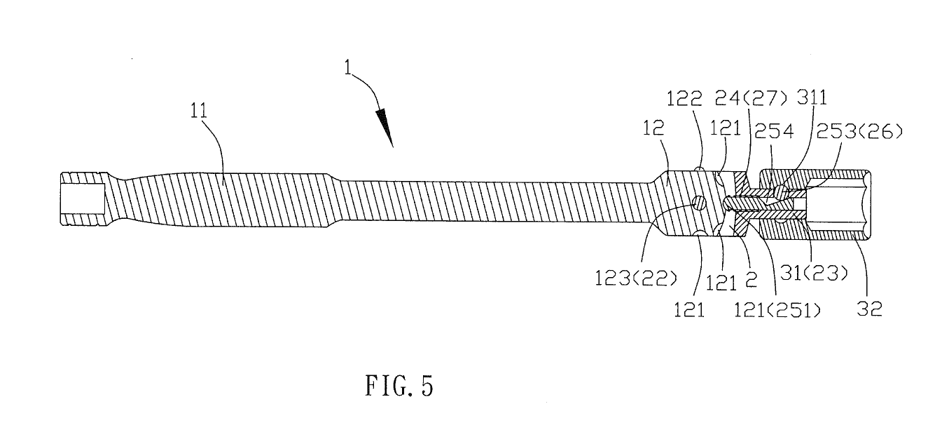

In operation, referring to FIGS. 4 and 5 with reference to FIGS. 1-3, the socket tool is used to operate a driving socket 3. The driving socket 3 has a first end provided with a first mounting hole 31 mounted on the connector 23 of the pivot member 2 and a second end provided with a second mounting hole 32 mounted on a workpiece, such as a nut and the like. The first mounting hole 31 of the driving socket 3 has a periphery provided with a locking groove 311. The positioning protrusion 251 of the quick release member 25 is pushed toward the mounting portion 12 of the handle 1 by the elastic force of the compression spring 27 so that the positioning protrusion 251 of the quick release member 25 is locked in a first one of the retaining grooves 121 of the handle 1 so as to temporarily position the pivot member 2 on the mounting portion 12 of the handle 1. At this time, the quick release member 25 is pushed toward the mounting portion 12 of the handle 1 by the elastic force of the compression spring 27, and the limit depression 253 of the quick release member 25 is moved to press the positioning ball 26 toward the driving socket 3, so that the positioning ball 26 is locked in the locking groove 311 of the driving socket 3 so as to lock the driving socket 3 onto the connector 23 of the pivot member 2. Thus, the handle 1 is rotated to rotate the driving socket 3 so as to drive the workpiece.

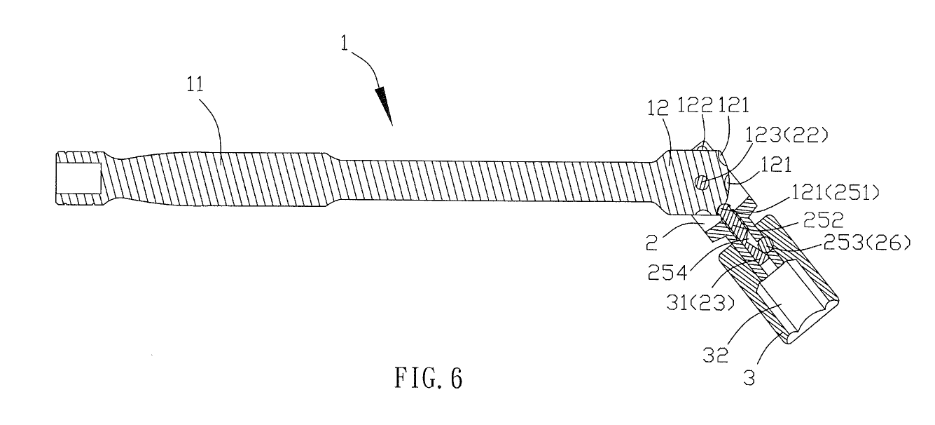

Alternatively, referring to FIG. 6 with reference to FIGS. 1-3, the pivot member 2 is pivoted about the threaded rod 22 to move relative to the mounting portion 12 of the handle 1 so as to adjust the angle between the pivot member 2 and the handle 1. When the positioning protrusion 251 of the quick release member 25 aligns with a second one of the retaining grooves 121 of the handle 1, the positioning protrusion 251 of the quick release member 25 is pushed toward the mounting portion 12 of the handle 1 by the restoring force of the compression spring 27 so that the positioning protrusion 251 of the quick release member 25 is locked in the second one of the retaining grooves 121 of the handle 1 so as to temporarily position the pivot member 2 on the mounting portion 12 of the handle 1. Thus, the angle between the handle 1 and the driving socket 3 can be adjusted.

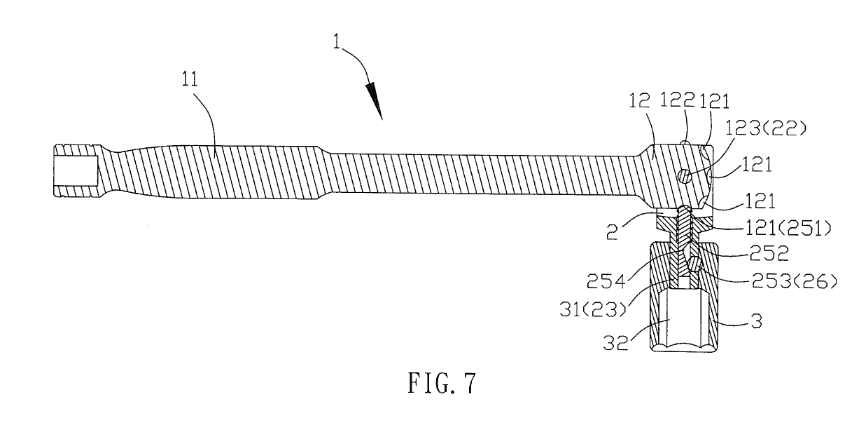

Alternatively, referring to FIG. 7 with reference to FIGS. 1-3, the pivot member 2 is further pivoted about the threaded rod 22 to move relative to the mounting portion 12 of the handle 1 so as to further adjust the angle between the pivot member 2 and the handle 1. When the positioning protrusion 251 of the quick release member 25 aligns with a third one of the retaining grooves 121 of the handle 1, the positioning protrusion 251 of the quick release member 25 is pushed toward the mounting portion 12 of the handle 1 by the restoring force of the compression spring 27 so that the positioning protrusion 251 of the quick release member 25 is locked in the third one of the retaining grooves 121 of the handle 1 so as to temporarily position the pivot member 2 on the mounting portion 12 of the handle 1. Thus, the angle between the handle 1 and the driving socket 3 can be further adjusted.

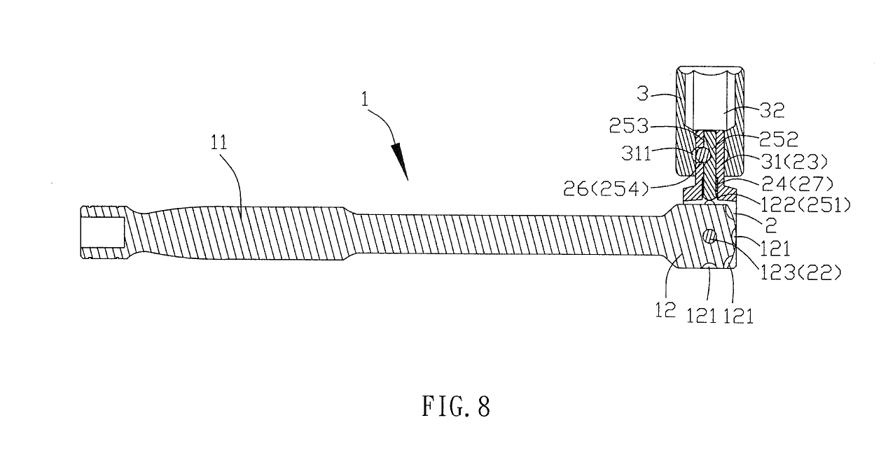

Alternatively, referring to FIG. 8 with reference to FIGS. 1-3, the pivot member 2 is pivoted reversely about the threaded rod 22 to move relative to the mounting portion 12 of the handle 1. When the positioning protrusion 251 of the quick release member 25 aligns with the pressing block 122 of the handle 1, the positioning protrusion 251 of the quick release member 25 is pressed and moved by the pressing block 122 of the handle 1, and the release recess 254 of the quick release member 25 is moved to align with the positioning ball 26, so that the positioning ball 26 is detached from the locking groove 311 of the driving socket 3 and is received in the release recess 254 of the quick release member 25 so as to unlock the driving socket 3 from the connector 23 of the pivot member 2. Thus, the driving socket 3 can be removed from the connector 23 of the pivot member 2 easily and quickly.

Accordingly, the quick release member 25 is mounted in the pivot member 2 and is locked in any one of the retaining grooves 121 of the handle 1 so that the angle between the handle 1 and the pivot member 2 can be adjusted freely to adjust the angle between the handle 1 and the driving socket 3 in a multi-stage manner so as to satisfy the requirement of different working sites and to facilitate the user operating the driving socket 3. In addition, when the quick release member 25 is pressed by the pressing block 122 of the handle 1, the positioning ball 26 is detached from the locking groove 311 of the driving socket 3 to unlock the driving socket 3 from the connector 23 of the pivot member 2, so that the driving socket 3 can be removed from the pivot member 2 easily and quickly for replacement of the driving socket 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A socket tool comprising:
a handle;
a pivot member connected with the handle;
a threaded rod connecting the pivot member and the handle;
a quick release member mounted in the pivot member; and
a compression spring mounted on the quick release member;
wherein:
the handle has a first end provided with a grip portion and a second end provided with a mounting portion;
the mounting portion of the handle is provided with a transverse through hole;
the mounting portion of the handle has an outer periphery provided with a plurality of retaining grooves and a pressing block;
the pivot member is mounted on the mounting portion of the handle;
the pivot member has a first end provided with a screw hole and a second end provided with a connector;
the connector of the pivot member has an interior provided with a channel;
the quick release member is mounted in the channel of the connector; and
the quick release member has a first end provided with a positioning protrusion.

2. The socket tool of claim 1, wherein the channel of the connector has a stepped shape.

3. The socket tool of claim 1, wherein:
the socket tool further comprises a positioning ball mounted on the pivot member;
the quick release member has a second end provided with a shaft;
the shaft of the quick release member is provided with a limit depression and a release recess connected to the limit depression; and
the positioning ball is received in the limit depression or the release recess of the quick release member.

4. The socket tool of claim 3, wherein the compression spring is mounted on the shaft of the quick release member and received in the channel of the connector.

5. The socket tool of claim 1, wherein the pressing block of the handle is integrally formed on the mounting portion.

6. The socket tool of claim 1, wherein the pressing block of the handle consists of a bore formed in the mounting portion and a ball embedded in the bore.

7. The socket tool of claim 1, wherein the positioning protrusion of the quick release member is received in one of the retaining grooves of the handle or abuts the pressing block of the handle.

8. The socket tool of claim 1, wherein the threaded rod extends through the screw hole of the pivot member and the through hole of the handle, with the pivot member being pivotally mounted on the mounting portion of the handle and is pivotable about the threaded rod.

9. The socket tool of claim 3, wherein the positioning ball is movably mounted on the connector of the pivot member and partially extended into the channel of the connector.

10. The socket tool of claim 1, wherein the compression spring is biased between the positioning protrusion of the quick release member and the connector of the pivot member to push the positioning protrusion of the quick release member toward the mounting portion of the handle.
